(19) United States
(12) Patent Application Publication
(10) Pub. No.: US 2011/0132548 A1
(43) Pub. Date: Jun. 9, 2011

(54) CYLINDRICAL COMPOSITE PART TAPE LAYING MACHINE

(75) Inventor: Denis DE MATTIA, Basse Goulaine (FR)

(73) Assignee: Airbus Operations (S.A.S.), Toulouse (FR)

(21) Appl. No.: 12/946,345

(22) Filed: Nov. 15, 2010

(30) Foreign Application Priority Data
Nov. 17, 2009 (FR) 09 58089

(51) Int. Cl. B32B 37/00; B32B 37/14

(52) U.S. Cl. 156/577

(57) ABSTRACT

The invention concerns a layup machine, economic in terms of capital costs, for producing large-sized cylindrical panels made of composite material covering an angular sector less than 360° and allowing high layup productivity. The device of the invention allows a fixed cylindrical mandrel to be placed on the machine's table and the tape laying head to be moved over the surface of this mandrel, the actuator carriage supporting said tape laying head moving around the mandrel along an at least partially circular track.

The invention belongs to the domain of tape laying machines for manufacturing parts made of composite material. More specifically the tape laying machine that is the subject of the invention is suitable for the layup of cylindrical parts with any cross-section. Such parts form, for example, sections of aircraft fuselage.

The layup consists of depositing composite material strips, usually pre-impregnated with resin, onto a template, or mandrel, reproducing the surface of the part to be produced. Said composite material strips are usually stored in rolls. They are unrolled and stuck on the surface of the mandrel by a tape laying head that moves across said surface at a controlled feed rate, known as work feed, in directions corresponding to the orientation of the layer of material deposited. According to known embodiments of the prior state of the art, the tape laying head supports other functions than depositing, such as a means of cutting strips.

Tape laying heads permitting high productivity, notably by depositing wide strips, are very bulky items which must be supported by a rigid structure designed to ensure the accurate positioning of the strips, especially if the tape laying head moves over the mandrel according to complex kinematics with 5 or more axes of movement. Patent application FR2919517 describes an example of a tape laying head designed for this type of operation.

According to the prior state of the art, the realization of the skin of an aircraft fuselage made of composite material essentially uses two technological solutions. The first, described for example in patent application EP1963079/US2009020645 in the name of the applicant, consists of producing substantially cylindrical sections by laying layers along the entire circumference of said fuselage. The layup method generally used for this type of realization uses a mandrel reproducing the shape of the section to be produced, said mandrel being rotated in front of means of laying the material able to move along at least one axis parallel to the mandrel's axis of rotation. Said mandrel thus rotates about its axis, always in the same direction of rotation and at a substantially constant speed.

The second solution, described in application EP2076430, also in the name of the applicant, consists of producing sections of fuselage by assembling large composite panels, which are both very long and cover an angular sector of 90° or more. The individual realization of such panels by the previous method involves reversing the mandrel's direction of rotation in order to perform the layup from one edge of the panel to the other. Carrying out these reversals of direction of rotation with large-sized mandrels is complicated because of their inertia. Even by combining several panels on the same mandrel in order to cover an angular sector of 360° and limit the number of reversals of direction of rotation, the great length of the mandrel suitable for this realization makes its manufacture complex and expensive if it must be rotated, given its weight. This weight and inertia also limit the speed of rotation of said mandrel, and thus the layup working feed rate and as a result the productivity of this layup method.

The weight of such a mandrel, suitable for its rotation, is detrimental to the accuracy of the layup because the mandrel tends to deform under its own weight. The solution of using a fixed mandrel and moving the tape laying head over it, is also complicated to implement when the part has a large diameter, in particular with the machine tools of the prior state of the art whose kinematics is based on movement according to a Cartesian system. Actually, if the axis of the mandrel cylinder is positioned horizontally, such a configuration results in very demanding requirements in terms of strokes, especially in the vertical axis of the machine, which makes the production of such a machine expensive and complex. Moreover, this kinematic solution, even using an articulated tape laying head, does not generally permit angular coverage of the cylindrical portion greater than 180° to be obtained while maintaining the head oriented normally to the surface during layup. Finally the surface path requires movement along 6 axes simultaneously in order to locate the tape laying head in space by position and orientation. The mount for the tape laying head, which is heavy and cumbersome, at the end of a structure providing kinematics comprising 6 axes is complex and poses technical problems related to the rigidity of such an assembly.

Machines are known in the prior state of art, e.g. patent U.S. Pat. No. 1,783,637, for machining cumbersome cylindrical parts, especially by turning, in which the part is placed on a fixed platform and where the tool moves along a circular guide track around the part in order to perform the machining. However, this configuration is not suited for the layup of composite parts such as fuselage panels whose diameter is small compared to the length and in which the angular sector covered by the surface is less than 360° and even less than 270°. It would, indeed, be very difficult to maintain the mandrel suitable for producing such a part in a stable vertical position. Nor are these machines suitable for layup operations, since they do not have a sufficient number of axes for dynamically moving and orienting the tape laying head relative to the mandrel surface, and they remain limited to producing cylindrical surfaces of revolution.

There is therefore a need for a layup device, economic in terms of capital costs, for producing large-sized cylindrical panels made of composite material covering an angular sector less than 360° and allowing high layup productivity.

Throughout this text, unless specifically indicated, the term “cylinder” and the adjective “cylindrical” must be understood in their mathematical sense, namely:
A cylinder is a surface in the space defined by a generating straight line running along any closed planar generating curve retaining a fixed direction. This cylinder's generating curve is thus not necessarily circular and the surface of this cylinder is therefore not necessarily a surface of revolution.
A portion of the surface or volume of a cylinder satisfying the above definition is termed cylindrical.
According to this definition, a cylindrical surface is said developable because it can be mapped onto a plane preserving the distances measured on said surface between the points forming it.

To meet these requirements, the device of the invention comprises:
A fixed table defining a base plane able to receive a layup mandrel;
A gantry extending in a plane perpendicular to the base plane and able to move along a linear longitudinal axis perpendicular to the plane of the gantry and parallel to the base plane;
An actuator carriage able to support a tape laying head and able to move at a working feed rate in the plane of the gantry along a track, said track comprising a circular portion of finite radius, whose axis of gyration is parallel to the longitudinal axis and placed between the track and the table.

Thus the device of the invention allows a fixed cylindrical mandrel to be placed on the machine's table and the tape laying head to be moved over the surface of this mandrel, the actuator supporting the tape laying head along the track on the gantry.

Advantageously the track extends over an angular sector greater than 180°. This configuration allows the tape laying head to be moved along this track to cover a cylindrical layup surface covering such an angular sector without needing to carry out large-scale movements on the other axes of the machine. In this way tangential speeds of movement over the mandrel's surface are achieved and thus layup productivity levels comparable to those that can be obtained with flat layup. Moreover, the actuator carriage only includes 2 axes of rotation instead of the 3 required by the prior art, which gives the assembly more rigidity and accuracy.

To achieve such performance levels in respect of the accuracy of the trajectories, the actuator carriage movement relative to the gantry is preferably achieved by a linear motor along the track.

According to a first embodiment the actuator carriage comprises a linear movement axis of the actuator, known as the W axis, parallel to the plane of the gantry and perpendicular to the track. This configuration makes it possible to carry out the layup of all types of cylindrical surfaces whose normal at each point is substantially colinear to the W axis when the tape laying head is placed at this point by moving the machine's axes. In this case, the layup follows the circumferences, i.e. the lengthwise direction of the deposited strips is oriented at 90° relative to the axis of the cylinder.

To carry out more complex layups according to this first embodiment, the actuator carriage may comprise a rotary movement axis of the actuator around the W axis. This configuration allows the head to be oriented for carrying out layups that are parallel or crosswise relative to the axis of the cylinder, the normal of the surface produced always being substantially colinear to the W axis.

To carry out a layup over any cylindrical surface and in any layup direction whatsoever, the actuator carriage comprises a device for moving the actuator according to at least two axes of rotation and one translation along an axis perpendicular to the track and parallel to the plane of the gantry.

This first embodiment corresponds to the movement of the tape laying head by a device with an open or serial kinematic chain.

Alternatively, according to a second embodiment, the movement of the tape laying head at the actuator carriage can be achieved, at least for certain degrees of freedom, by a parallel or closed kinematic chain. This configuration gives the actuator increased dynamic stiffness.

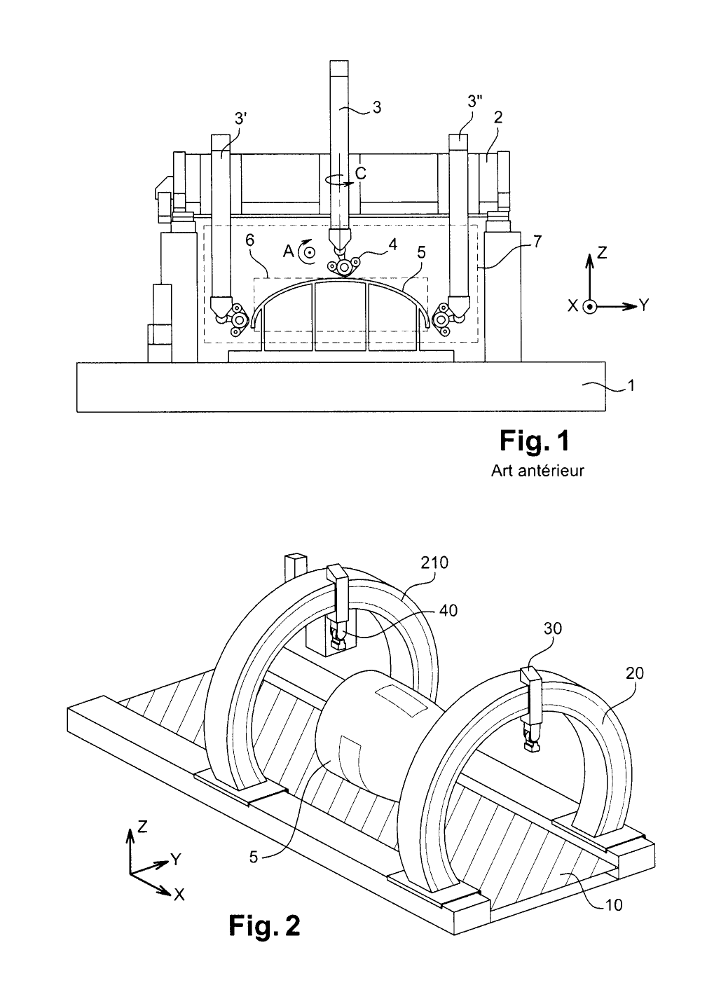

The invention will now be described more precisely in the context of preferred embodiments, that are in no way limiting, shown in FIGS. 1 to 5 in which:

FIG. 1, relating to the prior state of art, is a gantry-type of tape laying machine able to produce large-sized parts;

FIG. 2 shows in perspective an example of realization of the invention in the form of a machine whose gantries are annular;

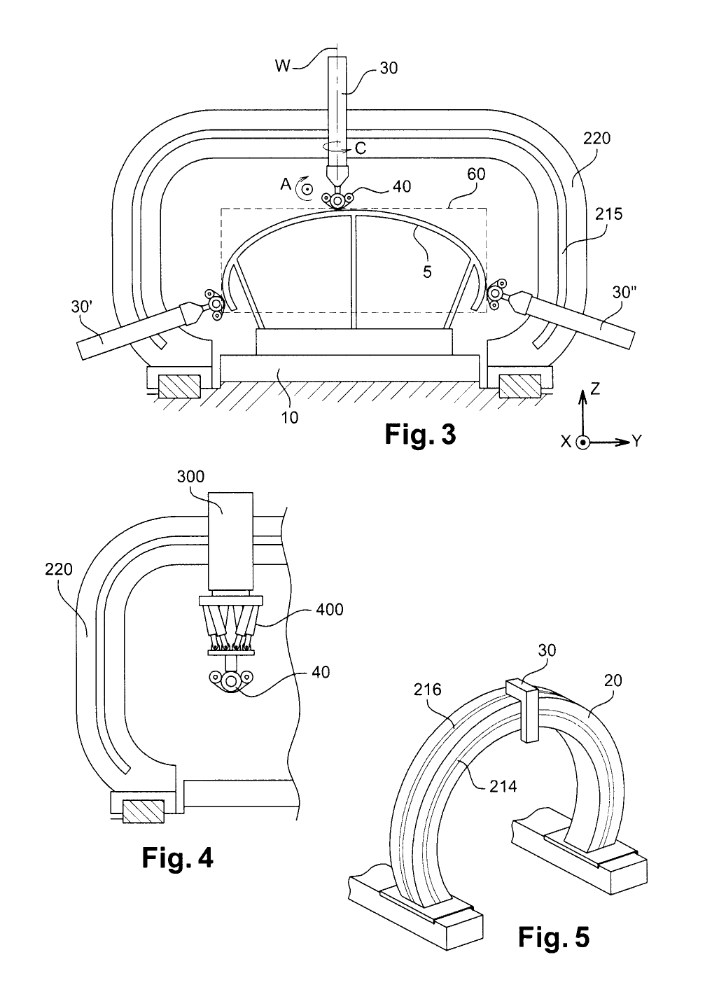

FIG. 3 shows a front view of a generalized embodiment of the invention using serial kinematics;

FIG. 4 shows an alternative realization of the invention using a device for moving the actuator using a closed parallel kinematic chain;

FIG. 5 shows an embodiment for moving the actuator carriage along the gantry.

FIG. 1, according to the prior state of art, the tape laying machines built according to an architecture of Cartesian movements, are comprised of:
a base (1) or table, extending along an XY plane,
on which a gantry moves along the X axis, said gantry comprising a crossbar (2) parallel to the Y axis,
an actuator carriage (3) extending along the Z axis and moving along the crossbar.
Said actuator carriage supports a tape laying head (4)
The tape laying head is most often connected to the actuator carriage by a double articulation allowing its rotation movement about Z, called the C axis, and a second articulation allowing its movement along an axis perpendicular to Z, called the A axis.

The movements along the X, Y and Z linear axes make it possible to describe any trajectory in the machine's workspace. Movements along the A and C rotation axes allow the tape laying head to be oriented such that the generator of the layup roll's contact with the surface of the mandrel is perpendicular to the trajectory. To layup a cylindrical surface, an appropriately-shaped mandrel (5) is placed on the table and the tape laying head is moved to the surface of this mandrel so as to deposit fiber strips on it. Said strips adhere to the mandrel by the natural tackiness at deposition temperature of the resin impregnating them.

The maximum area that can be laid up in this way is given by the strokes of the axes. Taking the extreme positions (3, 3′, 3″) of the tape laying head in a YZ plane, the accessible volume (6) for a cylindrical surface covering a 180° angular sector is less than 25% of the machine's internal volume (7). This volume is further reduced if the angular sector covered by the panel is greater than 180°. As a consequence, when the aim of the layup operation is to produce a large-sized cylindrical panel, such as an aircraft fuselage panel, the volume of the machine suitable for this operation quickly becomes very large, and, to maintain their rigidity, the constituent elements of such a machine must be over-sized. This results in large masses to be moved, which is unfavorable for the velocity and thus the productivity of said machine.

FIG. 2, according to a particular embodiment of the invention, the machine comprises a base (10) extending along the XY plane, a gantry (20) extending along the YZ plane and movable in translation along X relative to the base (10) and an actuator carriage (30) moving along this gantry. Whereas according to the prior state of art the actuator carriage only moves along the Y axis on the gantry's crossbar (2), the actuator carriage (30) of the machine according to the invention is able to move along the entire gantry (20). To this end said gantry (20) comprises at least one circular portion of axis of gyration parallel to the X axis and positioned between said gantry and the table (10) of the machine. In the example of realization in FIG. 2, the gantry is fully circular in shape and covers an angular sector greater than 180°. The mandrel (5) being placed fixed on the table (10), the actuator carriage, equipped with the tape laying head (40), can turn around the axis of the cylindrical surface of the mandrel following a track (210) along the gantry. For very large-sized parts, the machine can comprise several gantries, each equipped with an actuator carriage and a tape laying head, that can simultaneously layup layers on the surface of the part to increase productivity. Alternatively, the different gantries can be equipped with different actuators, for instance a tape laying head, a seaming head or an ultrasound inspection head or any other device.

FIG. 3, according to a more general case of a realization of the invention, the gantry (220) is of any shape whatsoever but extends along the XY plane of the machine and comprises at least one circular portion allowing the actuator carriage (30) to carry out, following the gantry, a trajectory not parallel to the Y axis of the machine. During its movement, the actuator carriage (30) follows a track on this gantry. The track guides the actuator carriage. It can be advantageously carried out by an HMG type of guide rail distributed by THK®. Movement along this rail can be achieved by any means known to the person skilled in the art, notably by a rack-and-pinion device. According to a more advantageous embodiment, movement along the track is communicated to the actuator carriage (30) by a linear motor (215) arranged along the track. Advantageously the device also comprises a linear encoder allowing the actuator mount's exact position along said track to be known. According to a first embodiment of the driver, the permanent magnets constituting the secondary of the linear motor (215) are arranged on the gantry, perpendicular to the curve contained in the YZ plane of the machine and corresponding to the trajectory, their upper surface, being parallel to the YZ plane and opposite coils constituting the primary of the engine, arranged in the actuator mount. Alternatively, FIG. 5, the linear motors (216) can be arranged on the edge of the gantry. In this case, the guide rail (214) is preferably kept in the XY plane.

The actuator carriage (30) comprises an axis of movement of the actuator (40) parallel to the XY plane of the gantry, known as the W axis, and advantageously the tape laying head (40) is articulated at the end of the actuator carriage along an axis C coinciding with W and an axis A perpendicular to this latter. Thus, although the trajectory of the actuator carriage in the XY plane is constrained by the shape of the track, the trajectory followed by the actuator is modulated by its movement along W. For example, the actuator may, in the machine's workspace, FIG. 2, follow a trajectory corresponding to the surfaces of a cube whereas the gantries are circular in shape. The axes of rotation make it possible, during these trajectories, to orient the tape laying head such that its orientation conditions relative to the trajectory are met.

The actuator carriage movement along the track allows working feed rates over the cylindrical surface of the mandrel (5) to be obtained that are comparable to those obtained with flat layup.

FIG. 3 the accessible workspace (6) for tape laying up a cylindrical mandrel (5) reaches over 40% of the volume inside the machine.

According to another embodiment, an example of which is shown in FIG. 4, the actuator carriage (300) is extended by a parallel or closed kinematic chain device (400). Such a device, consisting for example of a hexapod, is able to move the actuator (40) by 6 degrees of freedom but in reduced amplitudes. According to this embodiment, the actuator carriage can be with or without an axis of movement W and the parallel kinematic device (400) can be connected to the actuator, carriage by a C axis articulation. The movements, even limited in amplitude, allowed by the parallel kinematic device can be advantageously used for the production, on the composite panel, of localized layup motifs, such as localized thickness reinforcements or patches.

The machine's movements are controlled by a numerical controller (not shown). An inverse kinematics calculation module is typically incorporated into this numerical controller, which allows the machine to be controlled using a program, known as tape, written in standard ISO code, the movement orders being expressed in the part's original space and translated by the calculation module into movement combinations along the machine's different axes. Said calculation module includes the algorithms making it possible to remove any kinematic ambiguities related to redundancies in movements or singular points. Alternatively, or additionally, the machine's specific kinematics can be integrated into the post-processor of a computer-assisted manufacturing system suited to the layup process. Thus, the machine's specific kinematics do not make the machine's programming more complicated than that of a 5- or 6-axis machine according to the prior state of art.

The above description clearly illustrates that through its various features and their advantages the present invention achieves the objectives it set itself. In particular, it allows the layup of large-sized cylindrical composite parts by reducing the machine's workspace compared to the volume of the tools required to produce these parts without rotating said mandrel. It also allows productivity and quality levels to be obtained that are comparable to those that can be obtained with flat layup.

1. Machine tool designed to layup layers of a composite material comprising:
a fixed table (1, 10) defining a base plane able to receive a layup mandrel (5);
a gantry (20, 220, 210) extending in a plane perpendicular to the base plane and able to move along a linear longitudinal axis (x) perpendicular to the plane of the gantry and parallel to the base plane comprising a guide track of an actuator carriage (30), said track comprising at least one circular portion of finite radius, whose axis of gyration is parallel to the longitudinal axis;
an actuator carriage (30) able to support a tape laying head (40) and able to move at a working feed rate in the plane of the gantry along the track (210), located between the track (210) and the table (10);
characterized in that the sum of the angular sectors of the circular portions of the track (210) is greater than 180°.

2. Machine according to claim 1 characterized in that it includes only one circular track (210).

3. Machine according to claim 1 characterized in that the movement of the actuator carriage (30) relative to the gantry (220) is realized by a linear motor (215) along the track (210).

4. Machine according to claim 1 characterized in that the actuator carriage (30) comprises a linear movement axis of the actuator, known as the W axis, parallel to the plane of the gantry and perpendicular to the track (210).

5. Machine according to claim 4 characterized in that the actuator carriage (30) comprises an axis of rotational movement (C) of the actuator about the W axis.

6. Machine according to claim 1 characterized in that the actuator carriage (30, 300) comprises a device for moving the actuator according to at least two axes of rotation (A, C) and one translation (W) along an axis perpendicular to the track (210) and parallel to the plane of the gantry.

7. Machine according to claim 6 characterized in that the device for moving the actuator comprises a closed kinematic chain (400).
